(19) United States
(12) Patent Application Publication
(10) Pub. No.: US 2022/0024249 A1
(43) Pub. Date: Jan. 27, 2022

(54) WHEEL MAINTENANCE DEVICE

(71) Applicant: ROBOTZONE, LLC, Winfield, KS (US)

(72) Inventor: Brian T. Pettey, Winfield, KS (US)

(21) Appl. No.: 17/148,167

(22) Filed: Jan. 13, 2021

Related U.S. Application Data
(60) Provisional application No. 63/056,101, filed on Jul. 24, 2020.

(51) Int. Cl. B60B 30/02; B60B 30/10

(52) U.S. Cl. CPC B60B 30/02; B60B 2900/321; B60B 2900/212; B60B 30/10

(57) ABSTRACT

A wheel maintenance device includes a wheel receiving component configured to support a wheel. The wheel maintenance device includes a wheel driving component configured to rotate the wheel.

### CROSS-REFERENCE TO RELATED APPLICATION

The present application is based on and claims the benefit of U.S. provisional patent application Ser. No. 63/056,101, filed Jul. 24, 2020, the content of which is hereby incorporated by reference in its entirety.

### BACKGROUND

Vehicles including cars, trucks, trailers, wheeled fish houses, motorcycles, all-terrain vehicles, aircraft, etc. are often suspended by a number of wheels. These wheels are coupled to the vehicle through a bearing. Many wheels include an inflatable rubber tire that contacts the ground. When a vehicle sits in place without moving for an extended period of time parts of the wheels may deteriorate.

### SUMMARY

A wheel maintenance device includes a wheel receiving component configured to support a wheel. The wheel maintenance device includes a wheel driving component configured to rotate the wheel.

### BRIEF DESCRIPTION OF THE DRAWINGS

FIG. 1 is a side view showing an example vehicle.

FIG. 2 is a side view showing an example wheel maintenance device.

FIG. 3 is a side view showing another example wheel maintenance device.

FIG. 4 is a side view showing another example wheel maintenance device.

FIG. 5 is a side view showing another wheel maintenance device.

FIG. 6 is a perspective view showing an example wheel maintenance device.

FIG. 7 is a top view showing an example wheel maintenance device.

FIGS. 8A-8B is a top view showing an example wheel maintenance device that is manually driven.

FIG. 9 is a block diagram showing an example tire maintenance device.

### DETAILED DESCRIPTION OF ILLUSTRATIVE EMBODIMENTS

Vehicles including but not limited to cars, trucks, trailers, tractors, wheeled fish houses, motorcycles, all-terrain vehicles, construction machines, etc. are often suspended by a number of wheels. These wheels are coupled to the vehicle through a bearing. Many wheels include an inflatable rubber tire that contacts the ground. When a vehicle sits in place without moving for an extended period of time, parts of the wheels may deteriorate. For example, the inflatable rubber tire can develop a flat spot from the weight being dispersed across the same portion of the tire. Or for example, the bearing can seize due to rust and lack or rotation. To prevent or reduce the chances of these problems from occurring a wheel maintenance device can be provided to rotate the wheel while the vehicle remains stationary. In some examples, where the vehicle has a powertrain, the wheel maintenance device can cycle portions of the powertrain to prevent these components from seizing.

The wheel maintenance device can be driven automatically such that the system be installed and automatically rotates the wheel at a given pace or intermittently rotates the wheel over time. In other examples, the wheel maintenance device can be manually driven by a user. For instance, the user can activate a motor manually to turn the wheel. Or for instance, the user can manually move the wheel using some on their own force (e.g., using a hand crank or foot pedal).

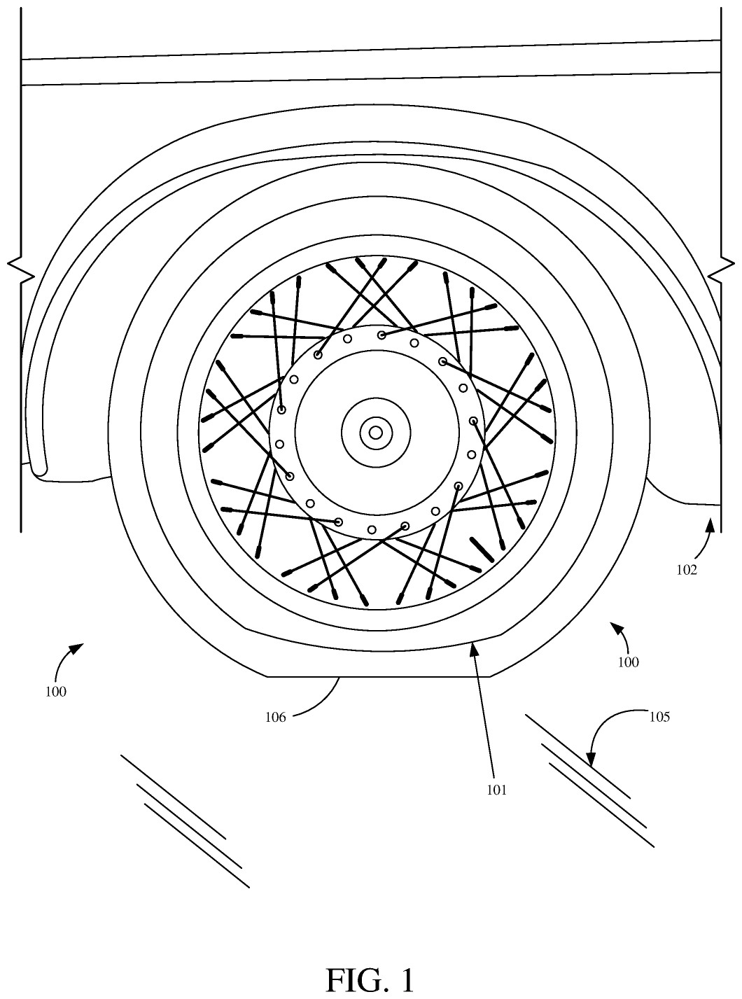

FIG. 1 is a side view showing an example vehicle 102 parked on a surface 105. Vehicle 102 as shown is a car, however, in other examples vehicles could include any transportation system with wheels, for instance, parked aircraft. Vehicle 102 is supported by one or more wheels 100 as it is parked on surface 105. Wheel 100 is coupled to the rest of vehicle 102 via a bearing 107 such that wheel 100 can rotate relative to other components of vehicle 102. Vehicle 102 and wheel 100 contact surface 105 through a tire 101. Typically, tire 101 is an inflatable rubber tire, but it could be other types of tires, in other examples. Over time, if vehicle 102 is not moved, tire 101 can develop a flat spot 106. Also, over time, if bearing 107 is not rotated it may seize and prevent or hinder rotation of wheel 100. Accordingly, a device can be provided that rotates wheel 100 over time as vehicle 102 is parked without the need of a moving vehicle 102. Rotation of wheel 100 prevents the formation of flat spots and also prevents bearing 107 from seizing in place. Rotation of wheel 100 while vehicle 102 is in a gear may also prevent portions of the powertrain from seizing.

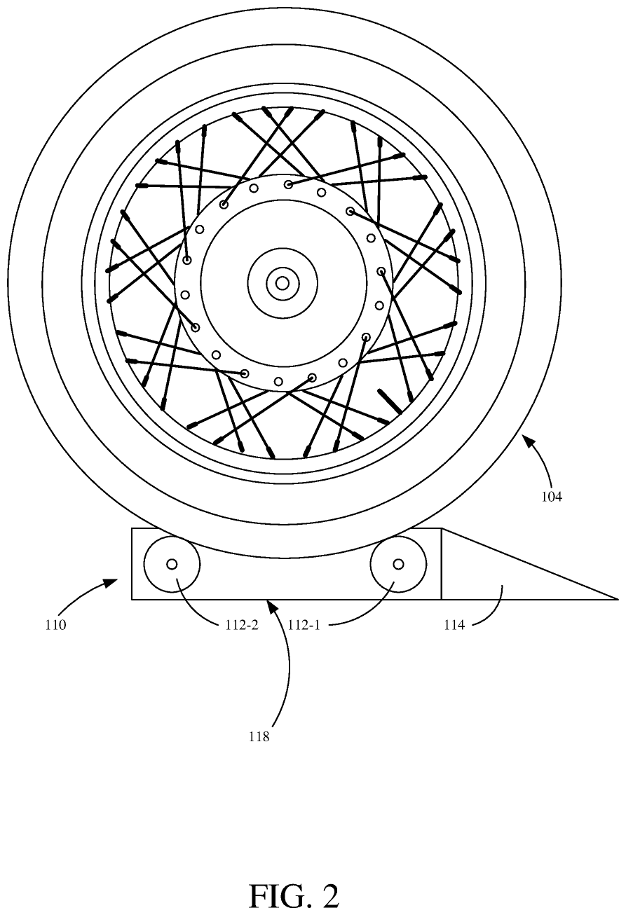

FIG. 2 is a side view showing an example wheel maintenance device 110. Wheel maintenance device 110 includes a ramp 114. Wheel 104 can ascend ramp 114 and seat within roller 112-1 and roller 112-2. Rollers 112-1 and 112-2 will be collectively referred to as rollers 112. Rollers 112 are shown as cylindrical rollers. However, the term roller should not be construed to only include cylindrical shapes. In other examples, rollers 112 could be spherical, disk, or other shapes as well. Rollers 112 are rotatably supported by frame 118 (e.g., coupled to frame 118 via a bearing that reduces friction and allows rollers 112 rotate). In some examples, rollers 112 can be disposed at a close to ground level or below ground level such that ramp 114 is not needed.

One of rollers 112 can be a driving roller that drives rotation of wheel 104. For example, wheel 104 may be rotated at the rate of one rotation a day, week, month, etc. depending on the environment that vehicle 112 is in. If vehicle 112 is outside or in a hostile environment wheel 104 may have to be rotated more frequently than if it were in a controlled interior environment. The rate of rotation can be chosen such that wheel 104 rotates and there is not enough time for tire 101 to develop a flat spot nor for bearing 107 or other components to seize. In some examples, more than one roller 112 drives wheel 104. One or more driving rollers 112 can include a high friction surface (e.g., a knurled surface, other textured surface, aluminum oxide, rubberized, adhesive, etc.). In another example, only one roller 112 drives wheel 104 and the other roller(s) are idle rollers that freely rotate with wheel 104. In some examples, one or more roller(s) 112 drives/supports multiple wheels at a time.

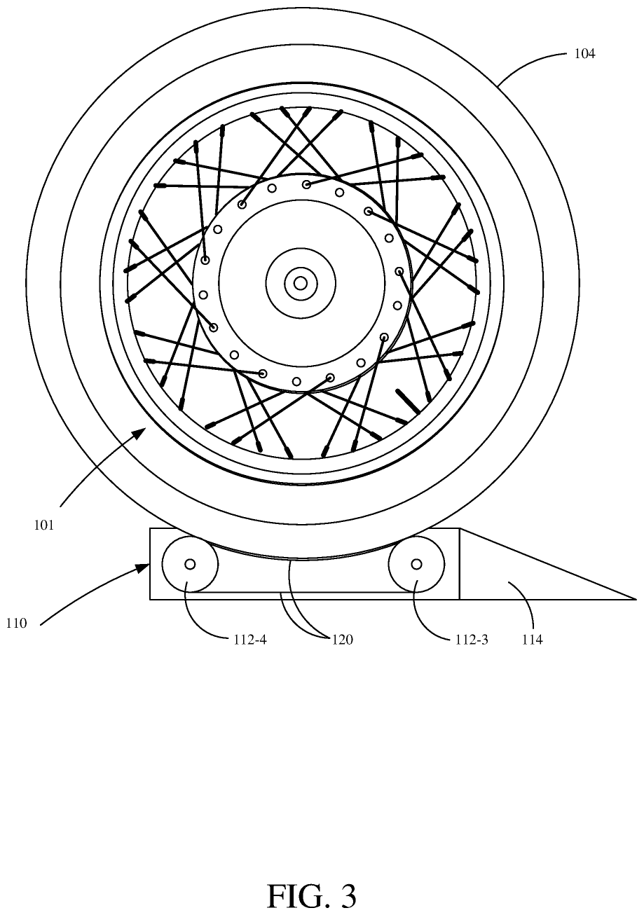

FIG. 3 is a side view showing another example wheel maintenance device 110. The components in this wheel maintenance device 110 are similar to that of FIG. 2 and similar components are similarly numbered. In this example, wheel 104 rolls up ramp 114 and seats on belt 120 that is suspended across rollers 112-3 and 112-4. Belt 120 can also include a tracks, slats or other continuous devices. Belt 120 allows for a greater surface area contact between the component supporting/driving wheel 104 and wheel 104. This greater surface area serves to further prevent flat spots being formed in tire 101 by reducing the pressure on any single point on tire 101. The greater surface area can also be used to drive wheel 104 with more force (e.g., without slippage) such that the powertrain can be driven as well. Similar to before, one or more rollers 112 can be driving or idling rollers, these rollers 112 rotate and drive belt 120.

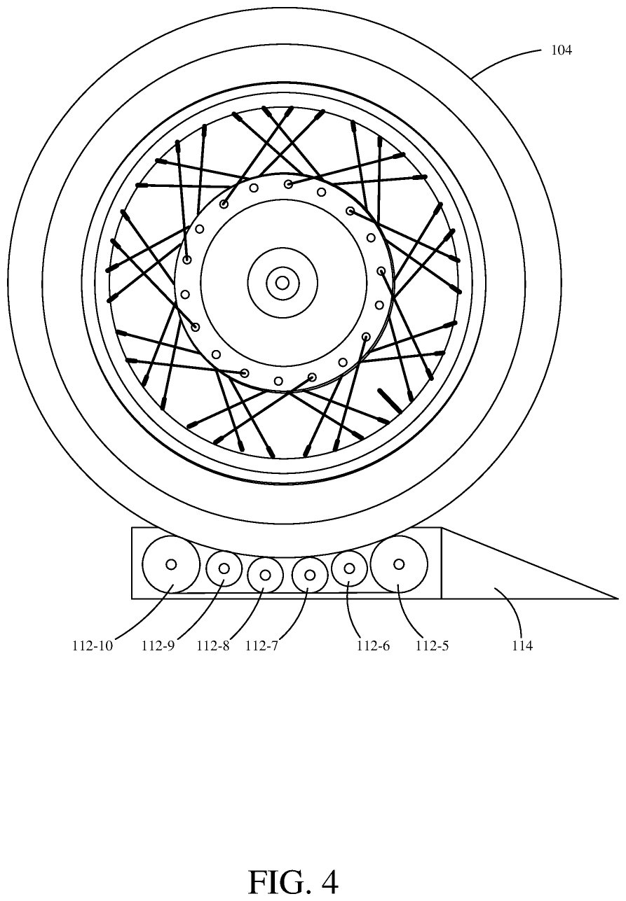

FIG. 4 is a side view showing another example wheel maintenance device 110. The components in this wheel maintenance device 110 are similar to that of the previous figures and similar components are similarly numbered. In this example, more than two rollers 112 are shown. Similar to belt 120, these rollers 112 also decreases the pressure along tire 110 and prevents the formation of a flat spot on tire 110. As shown, some of the rollers 112 are different sizes from one another. However, in other examples, the rollers may be the same size as the other rollers 112. As shown, rollers 112 are positioned in a circular orientation such that they conform to the outside surface of tire 101. In some examples, the rollers 112 are arranged for different tire sizes. In other examples, the rollers 112 are adjustable to accommodate different tire sizes. This adjustment can be done automatically (e.g., vertically spring-loading the rollers or vertically motor driven rollers, etc.) or manually adjusted (e.g., replaceable rollers, movable rollers, etc.).

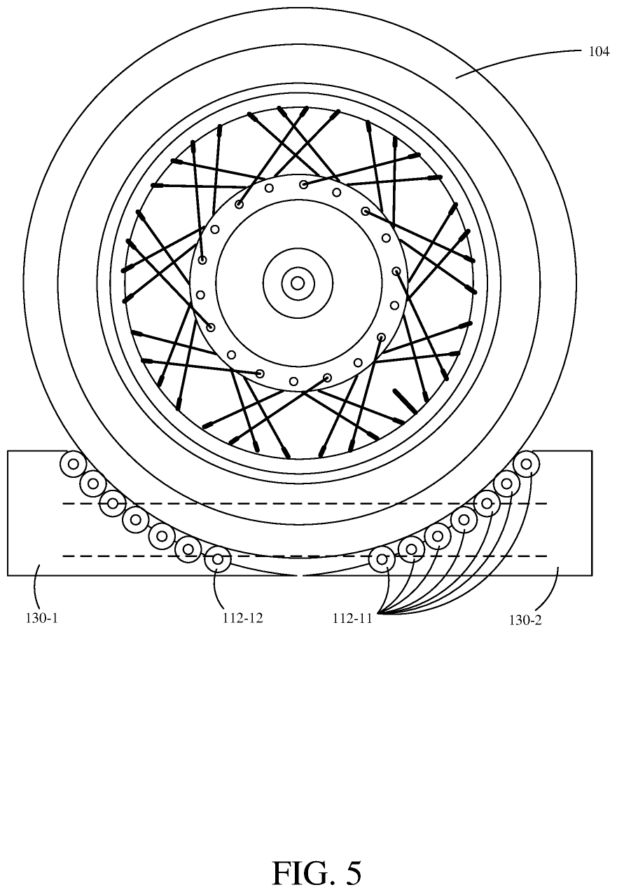

FIG. 5 is a side view showing another example wheel maintenance device 110. The components in this wheel maintenance device 110 are similar to that of the previous figures and similar components are similarly numbered. The shown wheel maintenance device 110 includes a first portion 130-1 and a second portion 130-2. These two portions 130 can be coupled to one another by a connector. A potential advantage to splitting wheel maintenance device 110 into two portions 130 is that the wheel maintenance device can be coupled to a stationary vehicle without having to start or roll the vehicle. This can be especially useful in tight spaces where many vehicles are parked and rolling or moving the vehicle is not feasible. In the shown example, a first portion 130 would be placed on the ground next the wheel and the second portion 130 would be placed on the other side and the connector would be tightened such that wheel 104 is lifted off of the ground and is supported by rollers 112. Rollers 112 will then allow for rotation of wheel 104. Connector can include a variety of different mechanisms such as a threaded connector, a latching lever, hydraulic actuator, a ratchet strap, linear actuators, etc.

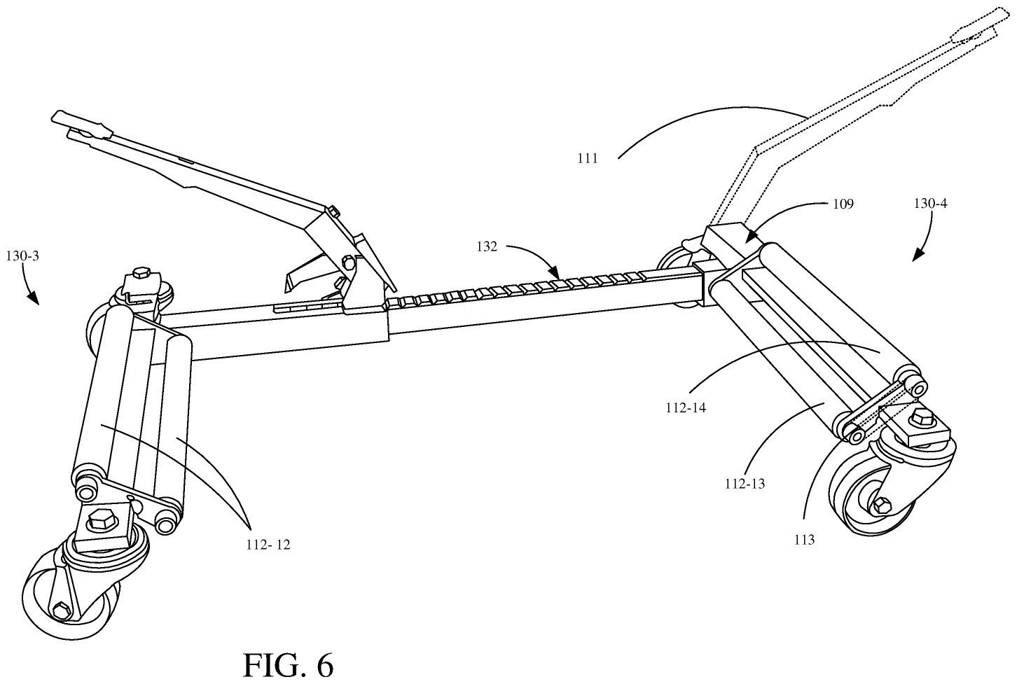

FIG. 6 is a perspective view showing an example wheel maintenance device 110. The components in this wheel maintenance device 110 are similar to that of the previous figures and similar components are similarly numbered. The shown wheel maintenance device 110 includes a first portion 130-3 and a second portion 130-4. These two portions can be coupled together by connector 132. Connector 132, as shown, includes a pedal and ratchet device. As the pedal is pumped the portions 130 are pulled together and into contact with rollers 112 which lifts the tire off the ground such that the tire is supported by rollers 112. Wheel maintenance device 110 of FIG. 6 may be useful to move from across multiple tires of one or more vehicles. For example, large parked aircraft can form tire flat spots relatively quickly across their tires and a single wheel maintenance device 110 can be used to rotate the tires. In some examples, the dual tires can be rotated by the same wheel maintenance device 110 at the same time.

As shown, at least one of the rollers 112 is coupled to wheel driving component 109. Wheel driving component 109 can include a motor that rotates roller 112-14. As shown, wheel driving component 109 can include a pedal 111 that drives roller 112-14. In some examples, roller 112-14 is coupled to roller 112-13 such that rotation of roller 112-14 causes roller 112-12 to rotate in the same direction. For instance, each roller 112 can be coupled to a corresponding sprocket/pulley and the sprockets/pullies are coupled together by a wheel receiving component 113.

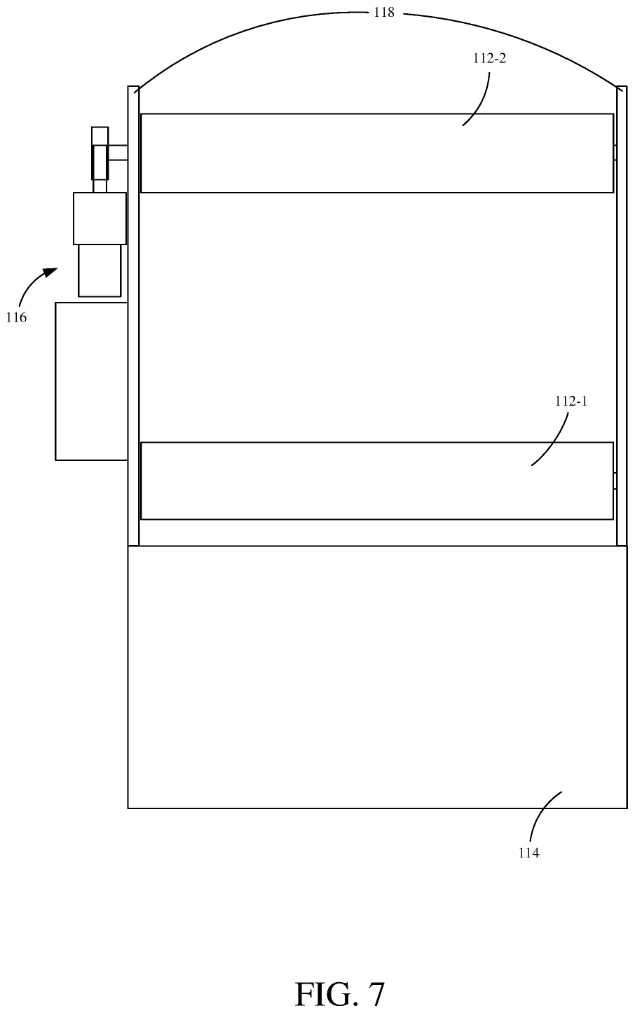

FIG. 7 is a top view showing an example wheel maintenance device 110. As shown, ramp 114 guides a wheel to rollers 112 which are supported by frame 118. Rollers 112 may be coupled to frame 118 via ball bearings or other bearings that reduce friction between roller 112 and frame 118. Roller 112-2 as shown, is coupled to a driving mechanism 116 that drives rotation of roller 112-2. Mechanism 116 includes a motor, a gearbox and a worm gear. Depending on the gear ratio within a gearbox a smaller or larger motor may be provided to drive roller 112-2. In some examples, the driving roller, or 112-2, can include a textured surface such that there is minimal slippage between the roller 112-2 and the wheel that it is driving. An electronic motor is only one example of a driving mechanism 116 and other mechanisms may also be provided to drive roller 112-2. In some examples, driving mechanism 116 can be in frame 118.

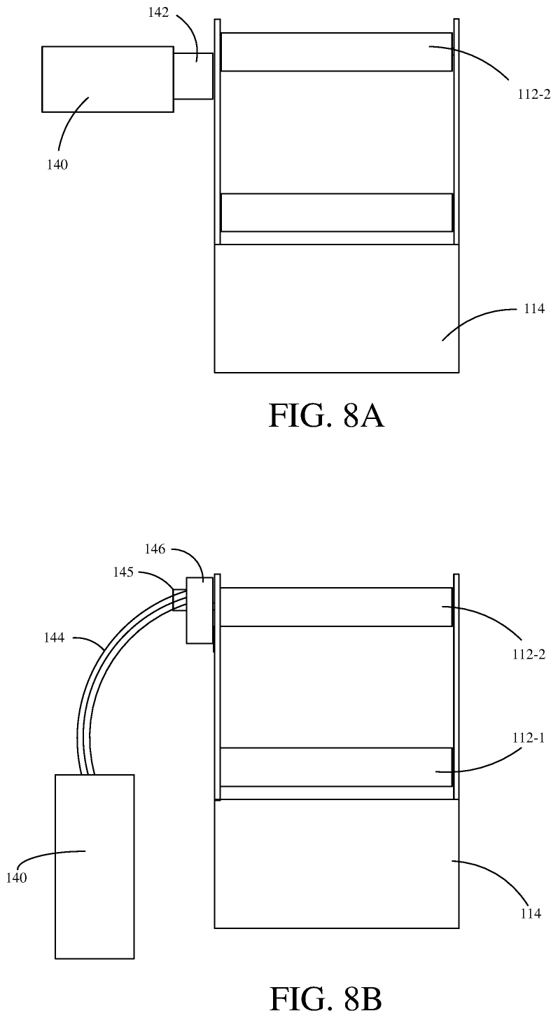

FIG. 8A is a top view showing an example wheel maintenance device that is manually driven. As shown, roller 112-2 is driven by pedal 140. As a user presses down on pedal 140, conversion mechanism 142 converts the pedal motion into rotational motion of roller 112-2. In one example, conversion mechanism 142 includes a chain drive coupled to pedal 140. As pedal 140 is driven up and down it can drive movement of chain through a ratchet device. The chain movement is then converted into rotational motion of roller 112-2.

FIG. 8B is a top view showing another example wheel maintenance device 110. Wheel maintenance device 110 is powered by pedal 140. Pedal 140, as shown includes a pneumatic or hydraulic cylinder that is driven with each pump of pedal 140. The generated pressure is provided to motor 146 via hoses 144. Motor 146 is shown is a pneumatic or hydraulic motor that rotates using hydraulic or pneumatic pressure. Hoses 144 are connected to motor 146 via quick connections 145. Pedal 140 and hoses 144 can be removed via quick connections 145 and allow pedal 140 can be used on multiple wheel maintenance devices 110.

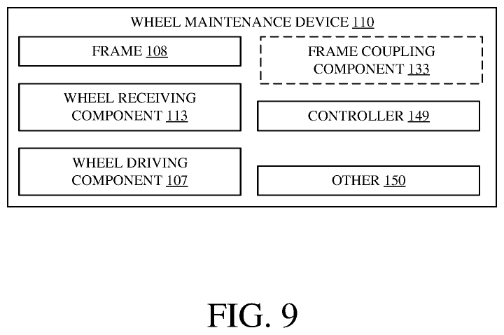

FIG. 9 is a block diagram of an example wheel maintenance device 110. Wheel maintenance device 110 includes frame 108, wheel receiving component 113, wheel driving component 109 and controller 149. Device 110 can also optionally include a frame coupling component 133 and can include other items as well, as indicated by block 150. Frame 108 supports device 110 and the weight of the supported vehicle 102. For instance, frame 108 supports wheel receiving component 113 and transfers the weight of the vehicle to the ground. Wheel receiving component 113 receives the tire/wheel of the vehicle and supports the tire/wheel. For example, wheel receiving component 113 can include a plurality of rollers and/or belts.

Wheel driving component 109 rotates a wheel/tire that is supported by wheel maintenance device 110. Wheel driving component 109 can include motors, power sources (e.g., batteries), manual driving devices (e.g., a pedal, a crank, etc.). Wheel driving component 109 can also include gearboxes or other power transferring devices to increase these with which the supported wheel is rotated. Controller 149 can control an actuator of wheel driving component 109 (e.g., a motor). Controller 149 can control the wheel driving component 109 to rotate at a semi-constant rate overtime. For example, wheel receiving component 109 can slowly drive the tire at one rotation an hour, a day, a week, a month or any given time. Controller 149 can control wheel driving component 109 to rotate the tire at intermittent times. For example, a quarter of a turn every few days. In some examples, the amount turned intermittently is randomized to avoid overexposure to one or more points on the tire (e.g., an exact quarter turn each time may overexpose the 4 same points on the wheel and might result in flat spots on those spots or seizes in other components).

Frame coupling component 133 couples multiple frame portions together. In some examples, frame coupling component 133 is also used to lift the tire off the ground. For example, frame coupling component 133 can include connector 132 in FIG. 6. In other examples, frame coupling component 133 could include threaded couplers, turn buckles, hydraulics, rack and pinions or any other linear actuator.

Although the present invention has been described with reference to preferred examples, workers skilled in the art will recognize that changes may be made in form and detail without departing from the spirit and scope of the invention.

1. A wheel maintenance device comprising:
a wheel receiving component that supports the wheel; and
a wheel driving component that rotates the wheel, the wheel driving component including a mechanical mechanism that drives rotation of a driving roller when a human actuates the mechanical mechanism, wherein the wheel rotates when the mechanical mechanism drives rotation of the driving roller.

2. The wheel maintenance device of claim 1, wherein the mechanical mechanism is a pedal.

3. The wheel maintenance device of claim 1, wherein the mechanical mechanism is a human operated, not powered mechanism.

4. The wheel maintenance device of claim 1, wherein the wheel receiving component comprises a belt.

5. The wheel maintenance device of claim 1, wherein the wheel receiving component includes an idle roller.

6. The wheel maintenance device of claim 1, wherein the driving roller comprises a textured surface.

7. The wheel maintenance device of claim 1, wherein the mechanical mechanism is a foot activated mechanism.

8. The wheel maintenance device of claim 1, wherein the mechanical mechanism is functionally engaged to the driving roller.

9. The wheel maintenance device of claim 1, wherein when the human actuates the mechanical mechanism, the driven rotation of the driving roller is such that the wheel is rotated less than a full rotation.

10. The wheel maintenance device of claim 9, wherein the wheel maintenance device is configured such that the human actuates the mechanical mechanism repeatedly in order to eventually cause the driving roller to actuate enough times to cause a full rotation of the wheel.

11. The wheel maintenance device of claim 1, wherein the wheel maintenance device is configured to completely rotate the wheel through repeated actuations of the mechanical mechanism.

12. A wheel maintenance device comprising:
one or more idle rollers configured to support a portion of weight of a vehicle;
one or more driving rollers configured to drive a wheel of the vehicle;
a foot pedal configured to drive the one or more driving rollers.

13. The wheel maintenance device of claim 12, wherein the foot pedal is mechanically engaged to the one or more driving rollers such that the foot pedal is configured to drive the one or more driving rollers by way of a mechanical, non-powered interaction.

14. The wheel maintenance device of claim 12, wherein the foot pedal is further configured to drive the one or more driving rollers without utilizing electrical power.

15. The wheel maintenance device of claim 12, wherein the foot pedal is further configured to drive the one or more driving rollers by a manual interaction between the foot pedal and the one or more driving rollers.

16. The wheel maintenance device of claim 12, wherein the foot pedal is mechanically engaged to the one or more driving rollers.

17. The wheel maintenance device of claim 12, the wheel maintenance device being further configured such that a human actuates the foot pedal repeatedly in order to eventually cause the one or more driving rollers to actuate enough times to cause a full rotation of the wheel.

18. The wheel maintenance device of claim 17, the wheel maintenance device being configured such that a human actuates the foot pedal one to cause a partial rotation of the wheel.

19. A tire maintenance device comprising:
a frame;
an idle roller coupled to the frame, the idle roller configured to support a portion of weight of a vehicle;
a driving roller coupled to the frame, the driving roller configured to contact and rotationally drive a tire of the vehicle; and
a foot pedal coupled to the frame and the driving roller, the foot pedal configured to rotate the driving roller.

20. The tire maintenance device of claim 19, wherein the foot pedal is further configured to rotate the driving roller manually.
